(19) United States
(12) Patent Application Publication
(10) Pub. No.: US 2013/0177293 A1
(43) Pub. Date: Jul. 11, 2013

(54) METHOD AND APPARATUS FOR THE ASSIGNMENT OF ROLES FOR IMAGE CAPTURING DEVICES

(71) Applicants: Sujeet Shyamsundar Mate, Tampere (FI); Igor Danilo Diego Curcio, Tampere (FI)

(72) Inventors: Sujeet Shyamsundar Mate, Tampere (FI); Igor Danilo Diego Curcio, Tampere (FI)

(73) Assignee: NOKIA CORPORATION, Espoo (FI)

(21) Appl. No.: 13/345,259

(22) Filed: Jan. 6, 2012

(51) Int. Cl. H04N 5/91

(52) U.S. Cl. 386/239; 386/E05.003

(57) ABSTRACT

A method, apparatus and computer program product are provided in order to assign roles to respective image capturing devices regarding at least one object that is a target during the subsequent recording. In the context of a method, at least one object is detected within a recorded image. The method may also cause information regarding the recorded image and information regarding the at least one object that was detected to be transmitted. The method may also include receiving an assignment of a role regarding at least one object being a target during subsequent recording. A corresponding apparatus and computer program product are also provided.

### TECHNOLOGICAL FIELD

An example embodiment of the present invention relates to image recording and, more particularly, to the assignment of roles to a plurality of image capturing devices to facilitate subsequent recording.

### BACKGROUND

Various image capturing devices have become prevalent in recent years as a variety of mobile devices, such as cellular telephones, video recorders or the like, having cameras or other image capturing devices have multiplied. As such, it has become common for a plurality of people who are attending the same event to separately capture video of the event. For example, multiple people at a concert, a sporting event or the like may capture video of the performers. Although each of these people may capture video of the same event, the video captured by each person will be somewhat different. For example, the video captured by each person may be from a different angle or perspective and/or from a different distance relative to the stage, the playing field or the like. Additionally or alternatively, the video captured by each person may focus upon different performers or different combinations of the performers.

In order to provide a more fulsome video of an event, it may be desirable to mix the videos captured by different people. However, efforts to mix the videos captured by a number of different people of the same event have proven to be challenging, particularly in instances in which the people who are capturing the video are unconstrained in regards to their relative position to the performers and in regards to the performers who are in the field of view of the videos.

### BRIEF SUMMARY

A method, apparatus and computer program product are therefore provided according to an example embodiment in order to assign roles to respective image capturing devices regarding at least one object that is a target during the subsequent recording. By assigning roles to the image capturing devices, the method, apparatus and computer program product of an example embodiment may facilitate the mixing of the recorded images provided by the image capturing devices. Additionally, the assignment of roles to the respective image capturing devices may reduce the redundancy between the recorded images provided by the image capturing devices. Further, the method, apparatus and computer program product of an example embodiment may facilitate content search and retrieval within the recorded images as a result of the assignment of roles to the respective image capturing devices.

In one embodiment, a method is provided that includes detecting, via a processor, at least one object within a recorded image. The method also causes information regarding the recorded image and information regarding the at least one object that was detected to be transmitted. In this regard, the information regarding the at least one object that was detected may include information regarding at least one of a shape of the at least one object, a distance of the at least one object, dimensions of the at least one object or a trajectory of the at least one object. The method of this embodiment may also include receiving an assignment of a role regarding at least one object being a target during subsequent recording.

The method may also cause context information associated with recorded information to be transmitted. The method may also accept the assignment of the role by tracking the target within the recorded image for at least a predetermined period of time. In one embodiment, the method may also cause an indication regarding a discontinuation of the role to be provided in an instance in which the target is no longer within the recorded image. A method of one embodiment may also associate an indication of the role with the recorded image, such as by tagging the recorded image.

In another embodiment, an apparatus is provided that includes at least one processor and at least one memory storing computer program code with the at least one memory and the computer program code being configured to, with the processor, cause the apparatus to at least detect at least one object within a recorded image and then cause information regarding the recorded image and information regarding the at least one object that was detected to be transmitted. In this regard, the information regarding the at least one object that was detected may include information regarding at least one of a shape of the at least one object, a distance to the at least one object, dimensions of the at least one object or a trajectory of the at least one object. The at least one memory and the computer program code may also be configured to, with the processor, cause the apparatus to receive an assignment of a role regarding at least one object being a target during subsequent recording.

The at least one memory and computer program code may be further configured to, with the processor, cause the apparatus to cause context information associated with recorded information to be transmitted. The at least one memory and the computer program code may be further configured to, with the processor, cause the apparatus to accept the assignment of the role by tracking the target within the recorded image for at least a predetermined period of time. In one embodiment, the at least one memory and the computer program code may be fully configured to, with the processor, cause the apparatus to cause an indication regarding a discontinuation of a role to be provided in an instance in which the target is no longer within the recorded image. The at least one memory and the computer program code of one embodiment may be further configured to, with the processor, cause the apparatus to associate an indication of the role with a recorded image such as by tagging the recorded image.

In a further embodiment, a method is provided that includes receiving information regarding a recorded image and information regarding at least one object that was detected to be within the recorded image from each of a plurality of image capturing devices. The method may also assign, with a processor to the respective image capturing device, a role regarding at least one object to be a target during subsequent recording based upon the information regarding the recorded image and the information regarding at least one object that is detected from each of the plurality of image capturing devices. In this regard, the method may assign the role by determining the at least one object has remained within the recorded image of a respective image capturing device for at least a predetermined period of time prior to assigning the role. The method may also cause the roles to be provided to the respective image capturing devices.

The method of one embodiment may also include determining that the information regarding the recorded images of a single event has been provided by a plurality of image capturing devices prior to assigning the roles. The method may also determine that at least two recorded images for which information has been provided by respective image capturing devices are overlapping. The method may also receive context information in association with recorded information. In this embodiment, the assignment of the role may include assigning the role based also upon the context information associated with the recorded image. The method of one embodiment may also cause at least one of a shape of the at least one object, a trajectory of the at least one object or an identification of the at least one object to be provided to the respective image capturing devices. The method of one embodiment may also discontinue assignment of the role to a respective image capturing device in an instance in which the target is no longer within the recorded image. The method may also associate an indication of the role with the information regarding the recorded image received from a respective image capturing device, such as by tagging the recorded image.

### BRIEF DESCRIPTION OF THE DRAWINGS

Having thus described certain example embodiments of the invention in general terms, reference will now be made to the accompanying drawings, which are not necessarily drawn to scale, and wherein:

FIG. 1 is a schematic representation of an event attended by a plurality of attendees;

FIG. 2 is a schematic representation of a plurality of image capturing devices recording images of a single event;

FIG. 3 is a schematic representation of a manner in which a plurality of image capturing devices are assigned roles in accordance with an example embodiment of the present invention;

FIG. 4 is a schematic representation of an apparatus that may include or be associated with an image capturing device in accordance with an example embodiment of the present invention;

FIG. 5 is a schematic representation of an apparatus that may be configured to assign roles to respective image capturing devices in accordance with an example embodiment of the present invention;

FIG. 6 is a flow chart illustrating operations performed by an apparatus that may include or otherwise associated with an image capturing device in accordance with an example embodiment of the present invention; and

FIG. 7 is a flow chart illustrating operations performed by an apparatus that may be configured to assign roles to respective capturing devices in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

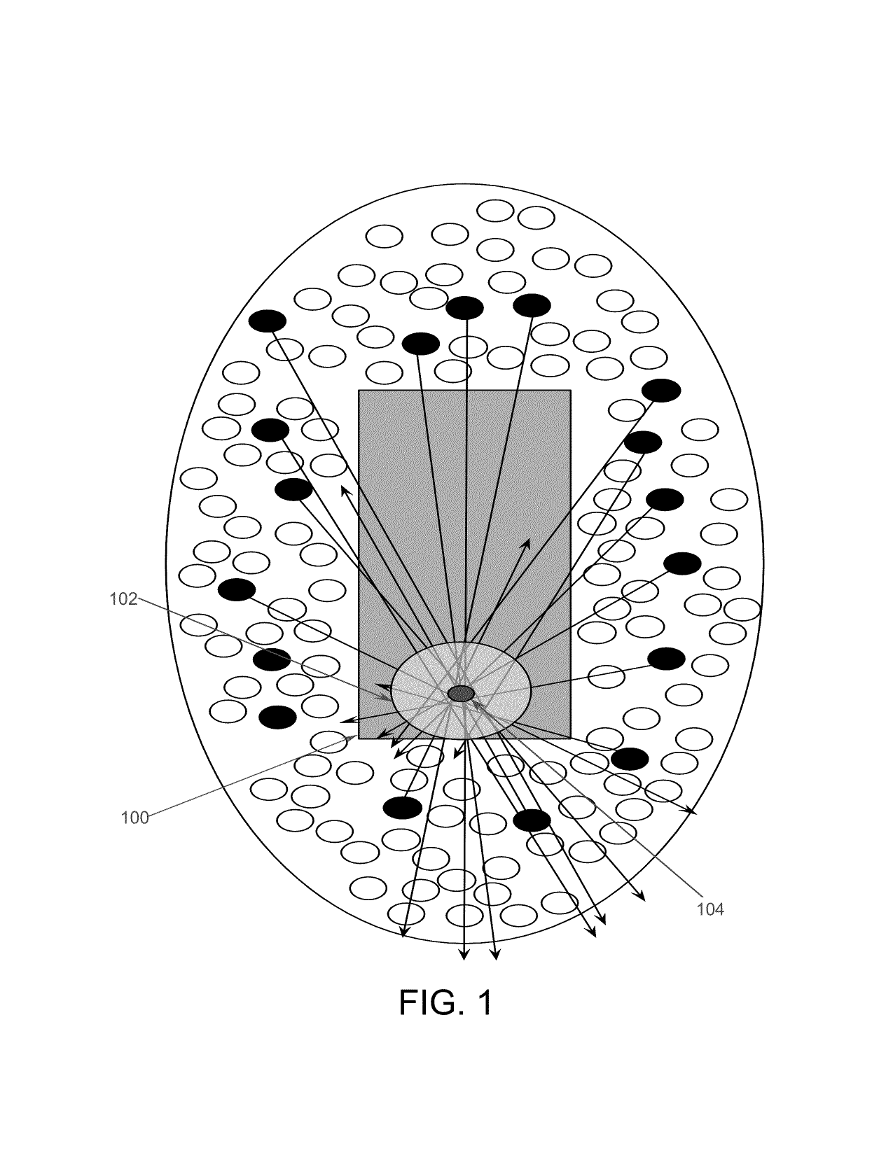

Referring now to FIG. 1, an event that may be attended by a number of people is generally illustrated. In this example, the event is a sporting event conducted on a sports field 100. Each of the circles surrounding the sports field represents an attendee with the shaded circles representing an attendee having an image capturing device for capturing an image of the play upon the sports field and the unshaded circles representing an attendee who is watching the play without an image capturing device. Within or proximate the sports field is an area of attraction 102, such as the general area within which play is currently occurring. Further, within the area of attraction is an area of focus 104, such as the area in which the most action, such as dribbling or shooting of a ball, is occurring. In this regard, the line of sight of each of the attendees or the line of sight of the image capturing devices operated by some of the attendees is represented by the lines emanating from each of the circles.

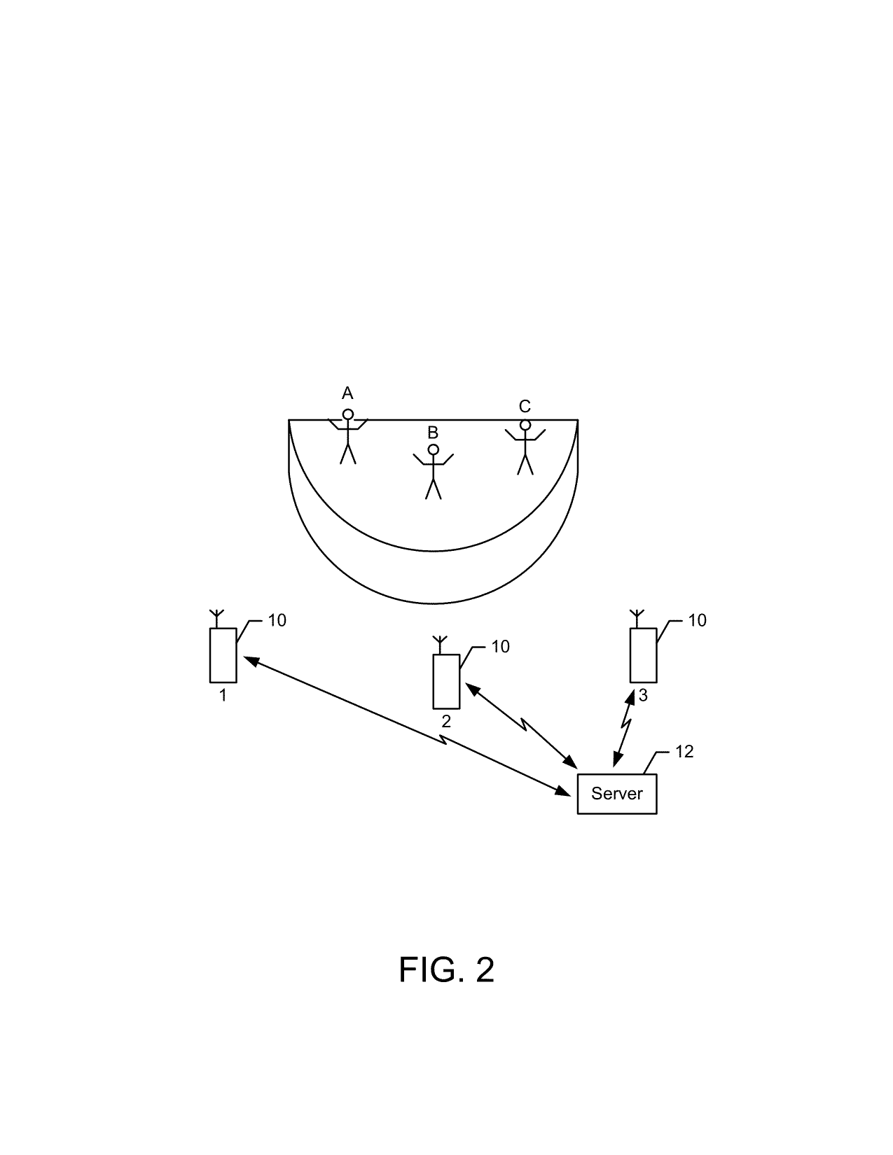

By way of another example, a concert is depicted in FIG. 2. While the concert depicted in FIG. 1 has three performers identified as A, B, and C who are performing as a group, the concert of FIG. 2 is only for purposes of example and the method, apparatus and computer program product may also be utilized in conjunction with a number of different types of events including sporting events as shown in FIG. 1, plays, musicals or other types of performances. Regardless of the type of event, a plurality of people may attend the event. As also shown in FIG. 2, a number of the people who attend the event may each have user equipment, such as a mobile terminal 10, that may include an image capturing device, such as a camera, for capturing images, such as video images, of at least a portion of the event. As used herein, an image may include one or more still images and one or more moving images, such as a video. For example, an image that is captured by the image capturing device may be a video, a picture or a series of pictures. With respect to the example depicted in FIG. 2, three mobile terminals designated as 1, 2, and 3 may be carried by three different attendees with each mobile terminal configured to capture a plurality of images, such as a video recording of at least a portion of the event. While the user equipment of the illustrated embodiment may be mobile terminals, the user equipment need not necessarily be mobile and, indeed, other types of user equipment may be employed.

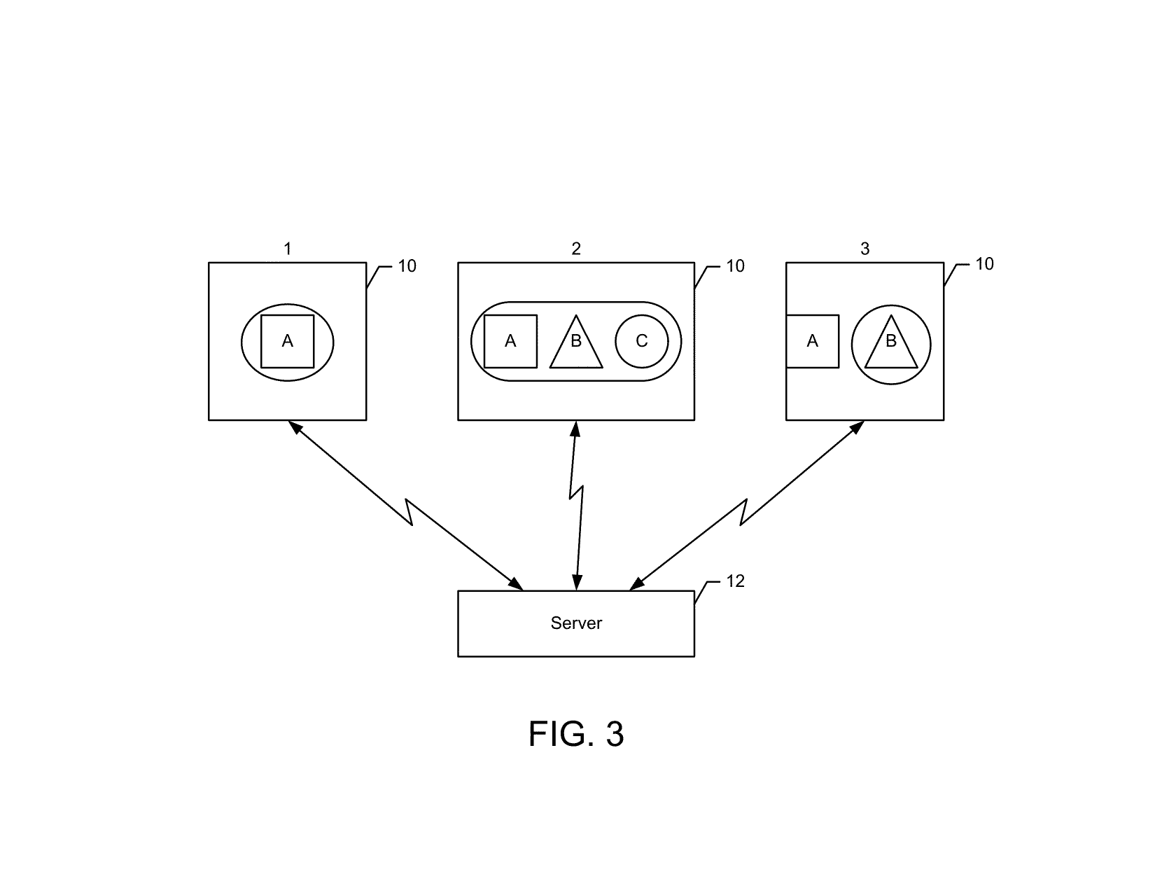

Based upon the relative location and orientation of each mobile terminal 10, the field of view of the image capturing device of each mobile terminal may include aspects of the same event. As shown in FIG. 3 by way of example, the image capturing device of the mobile terminal carried by Attendee 1 maybe focused upon Performer A so as to capture a video image that only includes Performer A. The image capturing device of the mobile terminal carried by Attendee 2 may, instead, have a field of view that captures the entire stage including each of the Performers A, B and C. Still further, the image capturing device of the mobile terminal carried by Attendee 3 may have a field of view that captures Performer B and a portion of Performer A without capturing Performer C. Thus, each of the mobile terminals of this example embodiment may capture images, such as a video recording, of the event, but the content of the images will be different.

As shown in FIG. 2, the mobile terminals 10 or other types of user equipment may provide the recorded images that have been captured of the event as well as other related information to a server 12 or other image processing device that is configured to store the recorded images and, in some instances to combine the recorded images captured by the various image capturing devices, such as by mixing the video recordings captured by the image recording devices. As shown in FIG. 2, the server or other image processing device that collects the recorded images captured by the image capturing devices may be a separate element, distinct from the user equipment. Alternatively, one or more of the user equipment may perform the functionality associated with the collection and processing, e.g., mixing or otherwise forming a combination, of the recorded images captured by the plurality of image recording devices. However, for purposes of example, but not of limitation, a server or other image processing device that is distinct from the user equipment including the image capturing devices will be described below.

As shown in FIG. 2, the plurality of mobile terminals 10 or other user equipment may communicate with the server 12 or other image processing device so as to provide information regarding the recorded images and/or related information, e.g., context information, in a variety of different manners including via wired or wireless communication links. Indeed, while the example of embodiment illustrates direct communications links between user equipment and the server or other image processing device, the system of another embodiment may include a network for supporting communications therebetween.

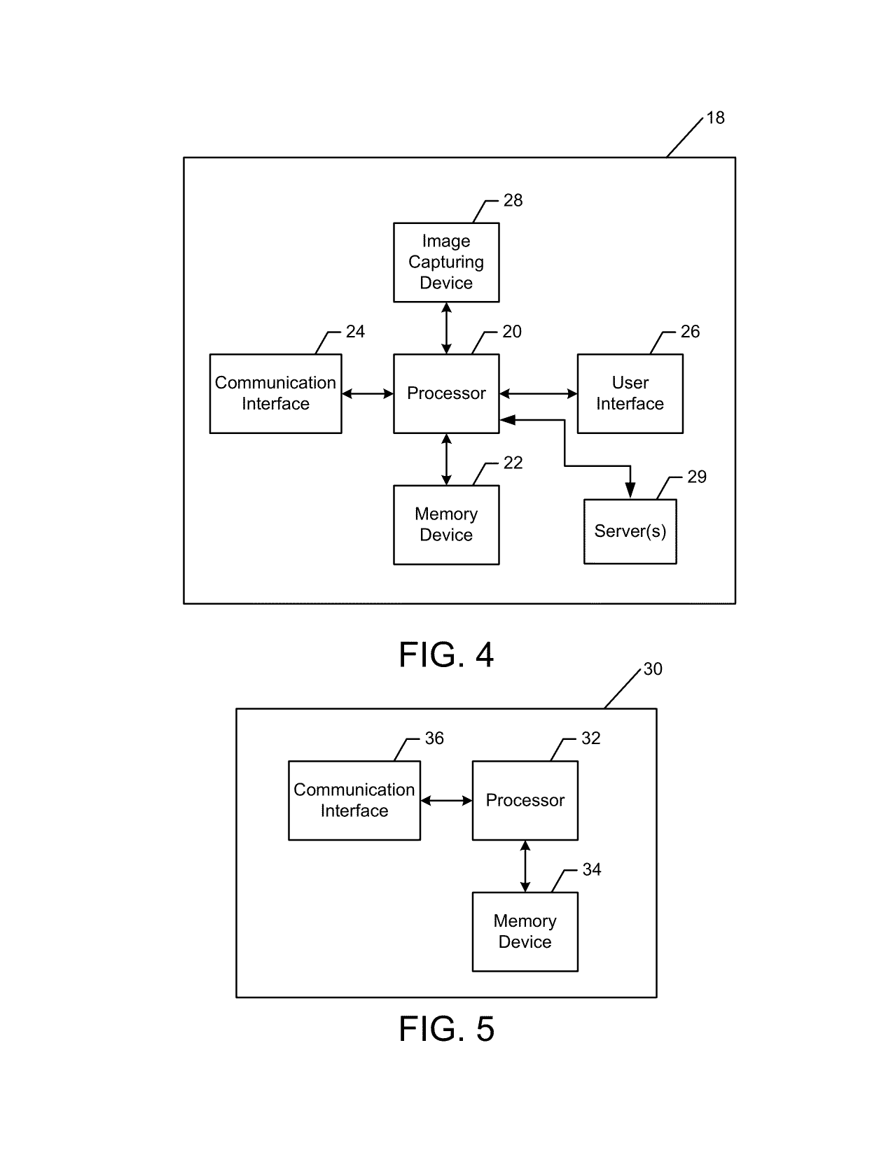

Referring now to FIG. 4, an apparatus 18 for capturing images of an event and for providing the recorded images and/or related information to a server 12 or other image processing device may include or otherwise be in communication with a processor 20, a memory device 22, a communication interface 24 and optionally a user interface 26. In some embodiments, the processor (and/or co-processors or any other processing circuitry assisting or otherwise associated with the processor) may be in communication with the memory device via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 18 may be embodied by a user terminal, such as a mobile terminal 10, although the user terminal may, instead, be a fixed (non-mobile) device or other computing device configured to employ an example embodiment of the present invention. However, in some embodiments, the apparatus or at least components of the apparatus, such as the processor 20, may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 20 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 20 may be configured to execute instructions stored in the memory device 22 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 24 may be any means such as a device or circuitry embodied in either hardware or a combination of hardware and software that is configured to receive and/or transmit data from/to a network and/or any other device or module in communication with the apparatus 18, such as the server 12 or other image processing device. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, such as instances in which the apparatus 18 is embodied by a user device, the apparatus may include a user interface 26 that may, in turn, be in communication with the processor 20 to receive an indication of a user input and/or to cause provision of an audible, visual, mechanical or other output to the user. As such, the user interface may include, for example, a keyboard, a mouse, a joystick, a display, a touch screen(s), touch areas, soft keys, a microphone, a speaker, or other input/output mechanisms. Alternatively or additionally, the processor may comprise user interface circuitry configured to control at least some functions of one or more user interface elements such as, for example, a speaker, ringer, microphone, display, and/or the like. The processor and/or user interface circuitry comprising the processor may be configured to control one or more functions of one or more user interface elements through computer program instructions (e.g., software and/or firmware) stored on a memory accessible to the processor (e.g., memory device 22, and/or the like). In other embodiments, however, the apparatus may not include a user interface.

The apparatus 18 may include or otherwise be associated or in communication with a camera or other image capturing device 28 configured to capture a series of images, such as a video, of at least a portion of an event. In an example embodiment, the image capturing device is in communication with the processor 20. The image capturing device may be any means for capturing an image for analysis, display and/or transmission. For example, the image capturing device may include a digital camera capable of forming a digital image file from a captured image. As such, the image capturing device may include all hardware, such as a lens or other optical device, and software necessary for creating a digital image file from a captured image. Alternatively, the image capturing device may include only the hardware needed to view an image, while the memory device 22 stores instructions for execution by the processor in the form of software necessary to create a digital image file from a captured image. In an example embodiment, the image capturing device may further include a processing element such as a co-processor which assists the processor in processing image data and an encoder and/or decoder for compressing and/or decompressing image data. The encoder and/or decoder may encode and/or decode according to a joint photographic experts group (JPEG) standard format or any other suitable format. The images that are recorded may be stored for future viewings and/or manipulations in the memory device.

The apparatus 18 may also optionally include or otherwise be associated or in communication with one or more sensors 29 configured to capture context information. The sensors may include a global positioning system (GPS) sensor or another type of sensor for determining a position of the apparatus. The sensors may additionally or alternatively include an accelerometer, a gyroscope, a compass or other types of sensors configured to capture context information concurrent with the capture of the images by the image capturing device 28. The sensor(s) may provide information regarding the context of the apparatus to the processor 22, as shown in FIG. 4.

Referring now to FIG. 5, an apparatus 30 for receiving information regarding images of an event from a plurality of mobile terminals 10 or other user equipment and for processing the images may include or otherwise be in communication with a processor 32, a memory device 34 and a communication interface 36. In some embodiments, the processor (and/or co-processors or any other processing circuitry assisting or otherwise associated with the processor) may be in communication with the memory device via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 30 may be embodied by a server 12 or other image processing device. As shown in FIG. 2 and discussed below, the server or other image processing device may be separate and distinct from the mobile terminals 10 or other user equipment, such that the apparatus 30 is similarly separate and distinct from the apparatus 18. In another embodiment, however, the server or other image processing device may be embodied by one or more of the user equipment such that the functionality described with regard to the apparatus 30 of FIG. 5 may be provided by the apparatus 18 of FIG. 4. Regardless, in some embodiments, the apparatus or at least components of the apparatus, such as the processor 32, may be embodied as a chip or chip set. In other words, the apparatus 30 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 30 may therefore, in some cases, be configured to implement an embodiment of the present invention on a single chip or as a single “system on a chip.” As such, in some cases, a chip or chipset may constitute means for performing one or more operations for providing the functionalities described herein.

The processor 32 may be embodied in a number of different ways. For example, the processor may be embodied as one or more of various hardware processing means such as a coprocessor, a microprocessor, a controller, a DSP, a processing element with or without an accompanying DSP, or various other processing circuitry including integrated circuits such as, for example, an ASIC, an FPGA, a MCU, a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 32 may be configured to execute instructions stored in the memory device 34 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a server or other image processing device) configured to employ an embodiment of the present invention by further configuration of the processor by instructions for performing the algorithms and/or operations described herein. The processor may include, among other things, a clock, an ALU and logic gates configured to support operation of the processor.

Meanwhile, the communication interface 36 may be any means such as a device or circuitry embodied in either hardware or a combination of hardware and software that is configured to receive and/or transmit data from/to a network and/or any other device or module in communication with the apparatus 30, such as the mobile terminals 10 or other user equipment. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, DSL, USB or other mechanisms.

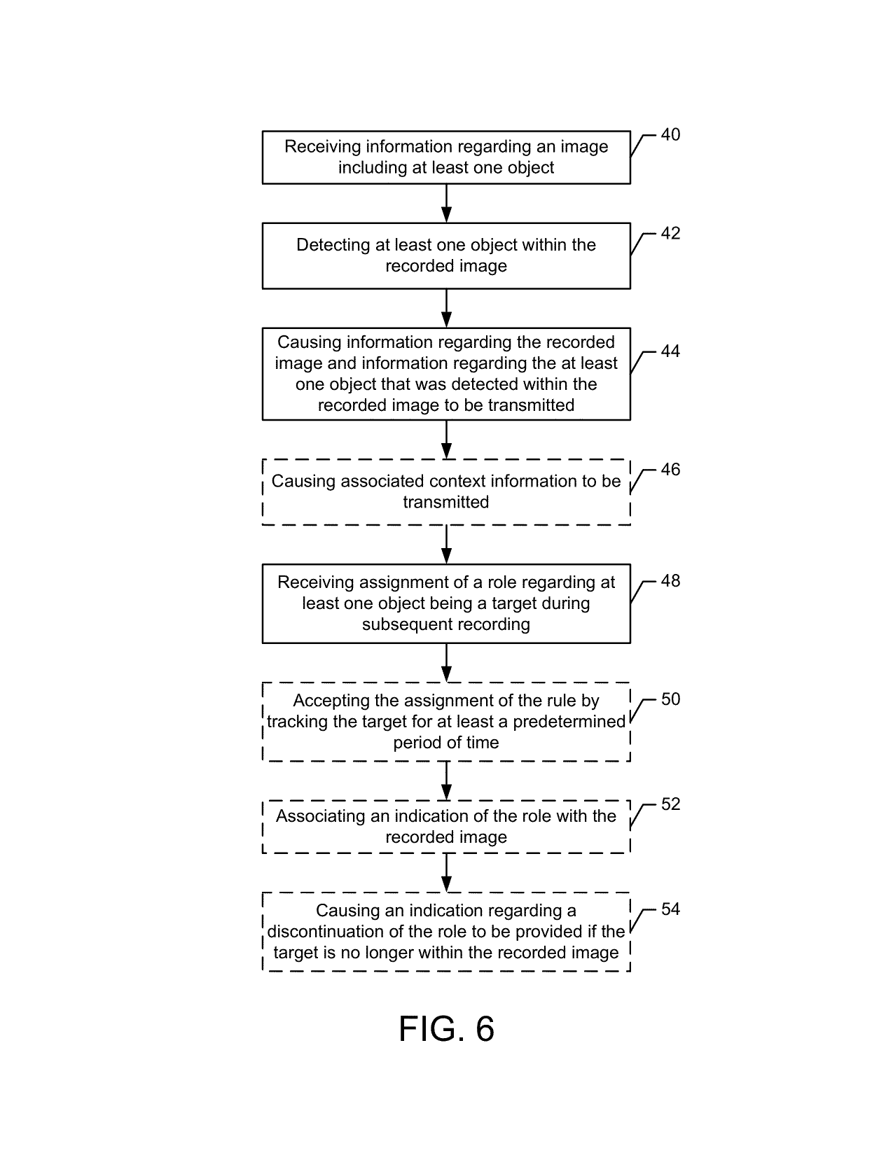

Referring now to FIG. 6, the operations performed by a method, apparatus and computer program product of an example embodiment as embodied by the mobile terminal 10 or other user equipment will be described. In this regard, the apparatus 18 embodied by the user equipment may include means, such as the processor 20, the image capturing device 24 or the like, for receiving information regarding an image including at least one object. See block 40 of FIG. 6. In one embodiment, the image is received by the image capturing device, such as a camera, that captures the image and, in turn, provides information regarding the image to the processor such that the processor also, in turn, receives the image. The apparatus, such as the image capturing device, the processor or the like, may receive a plurality of temporally sequential images, such as a video recording of the event. The object that is included within the image may be a variety of different types of objects, but, in one embodiment, is one or more performers that are taking part in the event, such as Performer A, Performer B, Performer C or some combination thereof. As noted above, the image capturing device may provide the image to the processor or may provide information regarding the image, such as information that extracted from and defining the image, e.g., information regarding object(s) within the image, the shape of the object(s) in either two or three dimensions, the size of the object(s) normalized by the image resolution, the distance of the object(s) from the image capturing device, the trajectory, etc., to the processor. In this regard, information regarding the image includes the image itself and/or information regarding the image.

As shown in block 42 of FIG. 6, the apparatus 18 may also include means, such as the processor 20 or the like, for detecting the at least one object within the recorded image. The apparatus, such as the processor, may detect the at least one object, such as one or more performers, utilizing any of a variety of object detection techniques including, for example, a face detection technique. In one embodiment, the apparatus, such as the processor, may not only detect the at least one object, such as one or more performers, but may also recognize the one or more objects, such as the one or more performers. In this embodiment, the apparatus, such as the processor, may utilize any object recognition technique including, for example, face recognition techniques. Based upon the object recognition, the apparatus, such as the processor, of this embodiment may be configured to identify the at least one object that was detected within the recorded image.

The apparatus 18 may also include means, such as the processor 20 and the like, for determining other information associated with the object that is detected to be within the recorded image. While the apparatus may be configured to determine a variety of other types of information related to the object, the apparatus, such as the processor, of one embodiment may be configured to determine the object's shape in a two dimensional (2-D) plane, the object's shape in a three dimensional (3-D) plane, the distance of the object from the image capturing device 28, the dimensions of the object, such as the dimensions of the object normalized by the size of the video or the size of the image, the trajectory of the object in the 2-D plane and/or the trajectory of the object in the 3-D plane.

The apparatus 18 may also include means, such as the processor 20, one or more sensors 29 or the like, for determining context information. As noted above, the apparatus of one example embodiment may include one or more sensors including, for example, a GPS or other position determination sensor, a gyroscope, an accelerometer, a compass or the like. As such, the processor may be configured to receive context information captured by the one or more sensors, such as information relating to the position and/or orientation of the apparatus, e.g., the position and/or orientation of the image capturing device at the time at which the image was captured. This context information may, in turn be associated with the recorded image as well as the other information associated with the at least one object detected within the recorded image.

As shown in block 44 of FIG. 6, the apparatus 18 may also include means, such as the processor 20, the communication interface 24 or the like, for causing information regarding the recorded image and information regarding the at least one object that was detected within the recorded image to be transmitted. As used herein, information regarding the recorded image includes the image itself and/or information regarding the image, such as information extracted from and defining the image. As described above, the information regarding the at least one object that was detected within the recorded image may include, for example, the object's shape, the distance to the object, the object's dimensions and/or the object's trajectory. The apparatus, such as the processor, the communication interface or the like, may also optionally be configured to cause the associated context information, if captured by the apparatus, to be transmitted in association with the recorded image. See block 46. The information regarding recorded image, the information regarding the at least one object that was detected within the recorded image and, in some embodiments, the related context information may be transmitted to the server 12 or other image processing device that is collecting the images captured by the various image capturing devices 28 that are present at the same event.

As described below, the server 12 or other image processing device may define a role for the respective apparatus 18 embodied by a mobile terminal 10 or other user equipment that identifies at least one object as a target for subsequent recording. As shown in block 48 of FIG. 6, the apparatus may therefore also include means, such as the processor 20, the communication interface 24 or the like, for receiving the assignment of a role regarding at least one object being a target during subsequent recording. In this regard, the role will generally assign one or more of the objects that were detected within the recorded image to be a target during subsequent recording. With respect to the foregoing example depicted in FIG. 3 in which the mobile terminal of Attendee 1 captures an image of Performer A, the mobile terminal of Attendee 2 captures an image including Performers A, B and C, and the mobile terminal of Attendee 3 captures an image of Performer B and a portion of Performer A, the mobile terminal of Attendee A may receive the assignment of a role in which Performer A is a target during subsequent recording, the mobile terminal of Attendee 2 may receive the assignment of a role in which all three Performers A, B and C are targets during subsequent recording and the mobile terminal of Attendee 3 may receive the assignment of a role in which Performer B is a target during subsequent recording. The assignment of the roles is represented by the manner in which one or more of the performers is encircled in the illustration of FIG. 3.

In one embodiment, the apparatus 18 may include means, such as a processor 20, user interface 26 or the like, for providing an indication to the user as to the role that has been assigned. In an example embodiment in which the user interface includes a viewfinder, a visible indication of the role may be displayed within the viewfinder such that a user looking through the viewfinder in order to capture an image of the event may be notified of the role that has been assigned. In other embodiments, however, the assignment of the role may be transparent to the user such that the user is not notified of the assignment of the role.

Regardless of the assignment of the role, the apparatus 18, such as the image capturing device 28, the processor 20 or the like, may continue to capture and receive images, such as a video recording, of at least a portion of the event. In one embodiment shown in block 50 of FIG. 6, the apparatus may optionally include means, such as a processor or the like, for accepting the assignment to the role in an instance which the target identified by the assignment to the role is tracked, such as by being included within the field of view of the image capturing device for at least a predetermined period of time following the assignment of the role. With respect to the mobile terminal of Attendee 1 of the foregoing example, the mobile terminal of Attendee 1 may accept the assignment to the role by maintaining Performer A within the images captured by the image capturing device for at least a predetermined period of time following the assignment of the role.

Regardless of whether the target remains within the field of view of the image capturing device 28, the apparatus 18 may continue to capture a series of images, such as a video recording, of the event, to determine information related to one or more objects within the recorded image and, in some instances, to associate context information with the recorded images and, in turn, to transmit information regarding the recorded images, the associated information regarding the detected object and the context information, if any, to the server 12 or other image processing device that is collecting the recorded images from the various image capturing devices. In one embodiment, the apparatus may optionally include means, such as the processor 20 or the like, for associating an indication of the role with the recorded image. See block 52 of FIG. 6. For example, the apparatus, such as the processor, of this embodiment may tag a recorded image, such as with metadata or other type of identifier, which identifies the role that has been assigned to the apparatus. As described below, the association of an indication of the role with a recorded image may facilitate the processing of the recorded image by the server 12 or other image processing device that is collecting the recorded images from the plurality of image capturing devices.

As noted above, the apparatus 18, such as the processor 20, may continue to detect the at least one object within the recorded images as additional images of the event are captured. In one embodiment, the apparatus, such as the processor, may not only detect the at least one object within the recorded image, but may determine if the object(s) detected within the recorded image includes the at least one object that is the target of the apparatus based upon the assignment of the role to the apparatus. In this embodiment, in an instance in which the apparatus, such as the processor, determines that the target is no longer within the recorded image, the apparatus may optionally include means, such as the processor, the communication interface 24 or the like, for causing an indication regarding a discontinuation of the role to be provided, such as to the server 12 or other image processing device that originally assigned the role and that is collecting the images collected by the plurality of image capturing devices 28. See block 54 of FIG. 6.

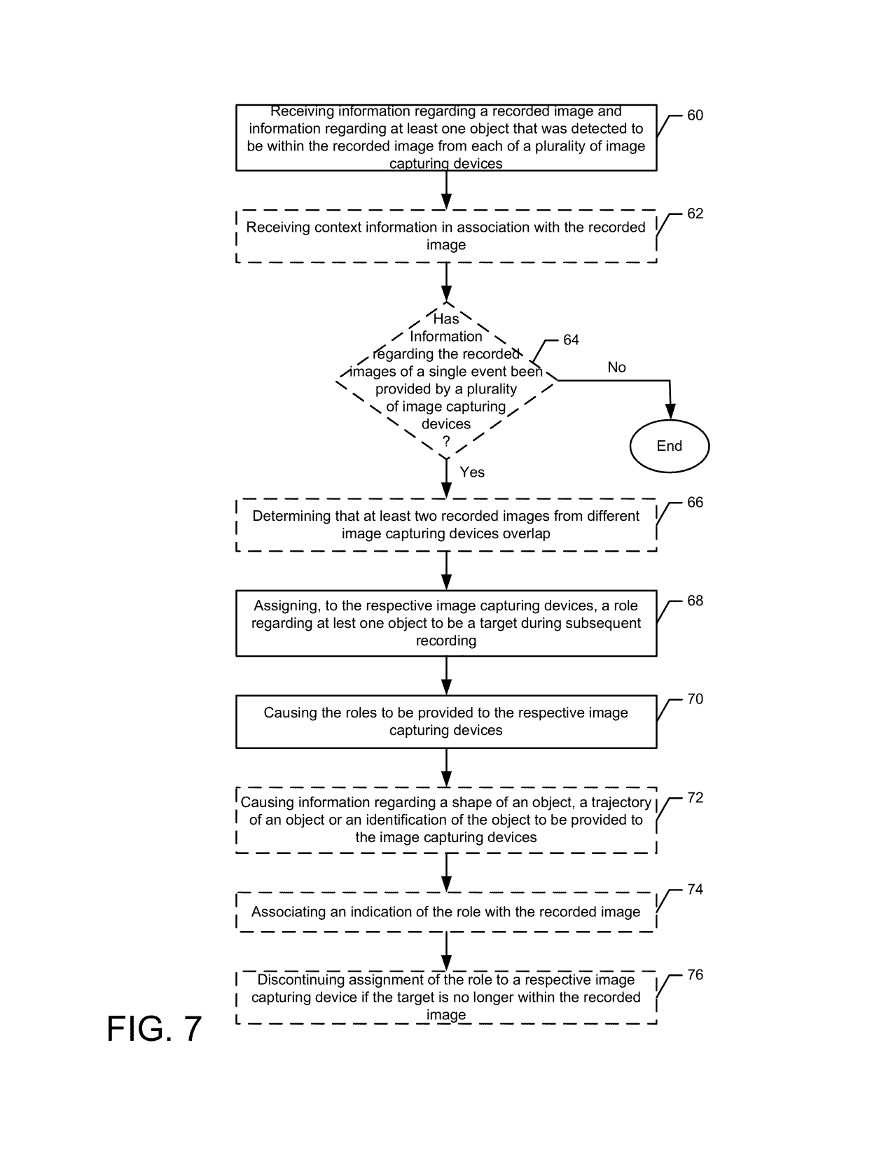

From the perspective of the server 12 or other image processing device that is collecting the images recorded by the plurality of image capturing devices 28, the method, apparatus and computer program product of one embodiment may be configured to perform at least some of the operations depicted in FIG. 7. In this regard, the apparatus 30 of one embodiment may include means, such as the processor 32, the communication interface 36 or the like, for receiving information regarding a recorded image and information regarding at least one object that was detected to be within the recorded image from each of a plurality of image capturing devices. See block 60 of FIG. 7. In those embodiments in which the mobile terminals 10 or other user equipment also capture content information associated with the recorded images, the apparatus, such as the communication interface, the processor or the like, may also receive the context information in association with the recorded images. See block 62 of FIG. 7.

Although the apparatus 18 embodied by the mobile terminals 10 or other user equipment may perform object detection and, in some instances, object identification, the apparatus 30 embodied by the server 12 or other image processing device may also include means, such as the processor 32 or the like, for determining one or more objects within a recorded image and/or identifying one or more objects detected within the recorded image.

In order to determine if the information regarding the recorded images and the associated information provided by the plurality of image capturing devices 28 relate to the same event, such as the same concert, the apparatus 30 may include means, such as the processor 32 or the like, for determining whether the information regarding the recorded images of a single event has been provided by the plurality of image capturing devices. See block 64 of FIG. 7. The apparatus, such as the processor, may determine whether the information regarding the recorded images is of a single event in various manners. In one embodiment, however, the apparatus may receive context information including, but not limited to, location information, horizontal orientation, vertical orientation, altitude, etc., from the mobile terminals 10 or other user equipment and the apparatus, such as a processor, may determine if the information regarding the recorded images from the plurality of image capturing devices is of the same event by comparing the context information of each user equipment. By way of example, the mobile terminals or other user equipment for which the location information is very similar, such as by being within a predefined threshold, may be considered to be in the same venue so as to be capturing images of the same event. Additionally or alternatively, the apparatus, such as a processor, may consider the information that was provided regarding the at least one object in the recorded images and may determine if one or more of the same objects are detected within the recorded images of two or more of the image capturing devices. If so, the apparatus, such as the processor, may determine that the information regarding the recorded images of the image capturing devices are of the same event.

In an instance in which the apparatus 30, such as a processor 32, determines that the information regarding the recorded images are not of the same event, the apparatus, such as the processor, the memory device 34 or the like, may store the information regarding the recorded images. However, in an instance in which the apparatus, such as a processor, determines that the information regarding the recorded images of two or more of the image capturing devices 28 are all of the same event, the apparatus may include means, such as the processor or the like, for assigning, to the respective image capturing devices, a role regarding at least one object to be a target during the subsequent recording. See block 68 of FIG. 7. As noted above, the at least one object that is to be a target is at least one of the objects detected to be within the recorded image for which information is received from the respective image capturing device. In instances in which the recorded images from the plurality of image capturing devices each include different objects, the apparatus, such as a processor, may simply assign roles such that the object(s) that are detected within the recorded images are the targets in subsequent recordings.

However, the apparatus 30 of one embodiment may include means, such as the processor 32 or the like, for determining that at least two of the recorded images from different image capturing devices 28 overlap with one another, such as the recorded images from the mobile terminals 10 of Attendees 1, 2 and 3 in the foregoing example. See block 66 of FIG. 7. In instances in which the apparatus, such as the processor, determines that at least two of the recorded images from different image capturing devices overlap, the apparatus, such as the processor, may determine the relative position of the image capturing devices, such as based upon position information provided by the user equipment and/or based upon a combination of the objects detected to be within the recorded images provided by the user equipment and an identification of the objects. Based upon the relative location of the image capturing device, the apparatus, such as the processor, may assign roles to the respective image capturing devices even in instances in which the recorded image captured by two or more of the image capturing devices overlap. In this regard, the apparatus, such as the processor, may assign roles such that the image capturing devices closer to a respective performer are assigned a role with the closer object being the target during subsequent recording. The apparatus, such as the processor, may also assign roles such that redundant roles are assigned for certain targets, but roles that are not redundant are assigned for other targets. For example, the lead singer of a musical act may be the target that is identified by the assignment of roles for a plurality of imaging capturing devices, while some of the performers in the background are only the target of a single image capturing device.

While the apparatus 30, such as the processor 32, may assign the roles to the various image capturing devices 28 based upon the information regarding one or more recorded images from the respective image capturing devices, the apparatus of one embodiment may review the information regarding a plurality of recorded images from each of the image capturing devices and may require the at least one object that is identified as a target by the assignment of a role to respective image capture device to be consistently within the recorded images of the respective image capturing device for at least a predetermined period of time.

Once the roles have been assigned, the apparatus 30, such as the processor 32, the communication interface 36 or the like, may cause the roles to be provided to respective image capturing devices 28, as shown in block 70 of FIG. 7. In one embodiment, the apparatus may also cause information regarding the shape of an object, the trajectory of an object and/or the identification of the object, that is, the identification of the object that is utilized by the server 12 or other image processing device, to be provided to the image capturing devices to facilitate subsequent tracking of the object by the image capturing device. See block 72 of FIG. 7. In this regard, although the apparatus 18 embodied by the mobile terminal 10 or other user equipment may determine information regarding the at least one object including the shape of the object, the distance to the object, the dimensions of the object and/or the trajectory of the object, the apparatus embodied by the server or other image processing device that collects information regarding the recorded images from a plurality of image capturing devices may also or alternatively include means, such as the processor or the like, for determining information regarding the at least one object that was detected within the recorded image provided by a respective image capturing device including, for example, the shape of the object and/or the trajectory of the object.

Following the assignment of the role, the apparatus 30 may include means, such as the processor 32, the communication interface 36 or the like, for receiving information regarding recorded images, such as video images, from the plurality of image capturing devices 28. As described above, the information regarding the recorded images provided by the mobile terminals 10 or other user equipment may include an indication of the role with the recorded image. However, in instances in which the information regarding the recorded images are not provided with an indication of the role, the apparatus embodied by the server 12 or other image processing device, such as the processor or the like, may associate an indication of the role with information regarding a recorded image, such as by tagging the information regarding the recorded image with metadata or another type of identification. See block 74 of FIG. 7. The apparatus embodied by the server or other image processing device, such as the processor, the memory device 34 or the like, may store the information regarding the sequence of recorded images provided by the plurality of image capturing devices, along with the information regarding objects detected within the recorded images, associated context information, if any, and information regarding the role associated with the recorded images.

The apparatus 30 embodied by the server 12 or other image processing device, such as the processor 32 or the like, may continue to analyze the information regarding the recorded images and may determine an instance in which the recorded image for which information is provided by respective image capturing device 28 no longer includes the object that is the target of the respective image capturing device. In this instance, the apparatus, such as the processor, may discontinue the assignment of the role to the respective image capturing device and, in one embodiment, may notify the respective image capturing device of the discontinuation of the assignment of the role. See block 76 of FIG. 7. Alternatively and as noted above, the discontinuation of the assignment of the role may be performed, instead, by the apparatus 18 embodied by the mobile terminal 10 or other user equipment and, in these embodiments, an indication of the discontinuation of the assignment of the role may be provided to the server or other image processing device.

As described above, the information regarding the recorded images provided by the plurality of image capturing devices 28 may be stored, such as within memory device 34. As a result of the assignment of roles to the respective image capturing devices, subsequent searches within the information regarding the recorded images, such as to identify one or more objects within the recorded images, such as video of one or more performers at an event, may be conducted more efficiently by referencing the roles assigned to the respective image capturing devices and searching the recorded image captured by the image capturing device(s) that were assigned a role having a target that is the subject to the search. The apparatus 30 embodied by the server 12 or other image processing device may also utilize the assignment of roles to the plurality of images capturing devices in order to facilitate mixing of the recorded images provided by the plurality of image capturing devices in order to create a composite series of images, such as a video remix or summary of the event. In this regard, the assignment of roles may reduce unnecessary duplication and may increase the likelihood that all of the relevant performers are included within the images recorded by respective image capturing devices, while still providing any desired redundancy for at least some of the performers.

As described above, FIGS. 6 and 7 illustrate flowcharts of an apparatus, method, and computer program product according to example embodiments of the invention from the perspective of an apparatus 18 embodied by a mobile terminal 10 or other user equipment and from the perspective of an apparatus 30 embodied by a server 12 or other image processing device. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture; the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. In this regard, FIGS. 6 and 7 illustrate several optional operations in blocks have dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
detecting, via a processor, at least one object within a recorded image;
causing information regarding the recorded image and information regarding the at least one object that was detected to be transmitted; and
receiving an assignment of a role regarding at least one object being a target during subsequent recording.

2. A method according to claim 1 further comprising causing context information associated with the recorded information to be transmitted.

3. A method according to claim 1 wherein causing information regarding the at least one object that was detected to be transmitted comprises causing information regarding at least one of a shape of the at least one object, a distance to the at least one object, dimensions of the at least one object or trajectory of the at least one object to be transmitted.

4. A method according to claim 1 further comprising accepting the assignment of the role by tracking the target within the recorded image for at least a predetermined period of time.

5. A method according to claim 1 further comprising causing an indication regarding a discontinuation of the role to be provided in an instance in which the target is no longer within the recorded image.

6. A method according to claim 1 further comprising associating an indication of the role with the recorded image.

7. An apparatus comprising at least one processor and at least one memory storing computer program code, the at least one memory and the computer program code configured to, with the processor, cause the apparatus to at least:
detect at least one object within a recorded image;
cause information regarding the recorded image and information regarding the at least one object that was detected to be transmitted; and
receive an assignment of a role regarding at least one object being a target during subsequent recording.

8. An apparatus according to claim 7 wherein the at least one memory and the computer program code are further configured to, with the processor, cause the apparatus to cause context information associated with the recorded information to be transmitted.

9. An apparatus according to claim 7 wherein the at least one memory and the computer program code are configured to, with the processor, cause the apparatus to cause information regarding the at least one object that was detected to be transmitted by causing information regarding at least one of a shape of the at least one object, a distance to the at least one object, dimensions of the at least one object or trajectory of the at least one object to be transmitted.

10. An apparatus according to claim 7 wherein the at least one memory and the computer program code are further configured to, with the processor, cause the apparatus to accept the assignment of the role by tracking the target within the recorded image for at least a predetermined period of time.

11. An apparatus according to claim 7 wherein the at least one memory and the computer program code are further configured to, with the processor, cause the apparatus to cause an indication regarding a discontinuation of the role to be provided in an instance in which the target is no longer within the recorded image.

12. An apparatus according to claim 7 wherein the at least one memory and the computer program code are further configured to, with the processor, cause the apparatus to associate an indication of the role with the recorded image.

13. A method comprising:
receiving information regarding a recorded image and information regarding at least one object that was detected to be within the recorded image from each of a plurality of image capturing devices;
assigning, with a processor to the respective image capturing devices, a role regarding at least one object to be a target during subsequent recording based upon the information regarding the recorded image and the information regarding at least one object that was detected from each of the plurality of image capturing devices; and
causing the roles to be provided to the respective image capturing devices.

14. A method according to claim 13 further comprising determining that information regarding the recorded images of a single event have been provided by a plurality of image capturing devices prior to assigning the roles.

15. A method according to claim 13 further comprising determining that at least two recorded images for which information has been provided by respective image capturing devices are overlapping.

16. A method according to claim 13 further comprising receiving context information in association with the recorded image, wherein assigning the role comprises assigning the role based also upon the context information associated with the recorded image.

17. A method according to claim 13 further comprising causing information regarding at least one of a shape of the at least one object, a trajectory of the at least one object or an identification of the at least one object to be provided to the respective image capturing devices.

18. A method according to claim 13 wherein assigning the role comprises determining that the at least one object has remained within the recorded image of a respective image capturing device for at least a predefined period of time prior to assigning the role.

19. A method according to claim 13 further comprising discontinuing assignment of the role to a respective image capturing device in an instance in which the target is no longer within the recorded image.

20. A method according to claim 13 further comprising associating an indication of the role with the information regarding the recorded image received from a respective image capturing device.

21. A method according to claim 13 further comprising determining a position of a respective image capturing device based upon the at least one object that was detected and identified to be within the recorded image.

22. A method according to claim 13 wherein assigning the role comprises assigning the role based on a relative position of a respective image capturing device.
